(19) United States
(12) Patent Application Publication
(10) Pub. No.: US 2021/0033722 A1
(43) Pub. Date: Feb. 4, 2021

(54) SYSTEM AND METHOD FOR INTER-SENSOR CALIBRATION

(71) Applicant: TRACKMAN A/S, Vedbaek (DK)

(72) Inventors: Thomas Søndergaard, Vedbaek (DK); Fredrik Tuxen, Rungsted Kyst (DK); Michael Ungstrup, Vedbaek (DK)

(21) Appl. No.: 16/524,823

(22) Filed: Jul. 29, 2019

(51) Int. Cl. G01S 13/86; G01S 7/40; G01S 13/66; G01S 13/89

(52) U.S. Cl. CPC G01S 13/867; G01S 13/89; G01S 13/66; G01S 7/4004

(57) ABSTRACT

A method includes capturing first data with a first sensor and second data with a second sensor in a multi-sensor tracking system, the first and second data corresponding to a path of an object, wherein each of the sensors has a set of initial parameters. The method includes generating a first initial object track using the first data and the first initial parameters and a second initial object track using the second data and the second initial parameters, matching the first and second initial object tracks and determining a degree of correspondence therebetween; and calculating first optimized parameters for the first sensor, wherein, when a first optimized object track is calculated using the first data and the first optimized parameters, the first optimized object track and the second initial object track have a higher degree of correspondence therebetween than the first and second initial object tracks.

### FIELD

The present disclosure relates to a system and a method for inter-sensor calibration. In particular, the present invention relates to systems and methods for near real-time inter-sensor calibration by tracking moving objects in situ.

### BACKGROUND

Moving objects are typically tracked by a single sensor, but benefits arise when extending the setup to a multi-sensor tracking system. One benefit is that multiple sensors typically expand the capture volume of the tracking system; another is that multiple sensors may provide redundant measurements, which may improve accuracy and highlight outlier measurements. Furthermore, sensors of different types may be combined that complement one another. For instance, a camera sensor, providing high angular accuracy both horizontally and vertically, may suitably be combined with a radar, giving accurate measurements of range and range rate. In any case, all sensors must be calibrated to one another to achieve those benefits.

As an example of a multi-sensor tracking system, a golf ball tracking system may include one or more cameras or radars, a combination of cameras and radar, and other sensors tracking different and/or overlapping portions of the flight of a golf ball. Each of the sensors acquires object data made up of measurements of the ball at one or more times, in a coordinate system specific to the device and, when calibrated to one another, their data may be projected into a global coordinate system with a high degree of consistency for further processing and fusion of data.

Calibrating a sensor requires a determination of various parameters, both internal and external to the sensor. Internal parameters may comprise of a focal length, lens distortion parameters and a principal point for a camera, and phase offsets for a radar. External parameters typically constitute a sensor's position and orientation. Known methods for determining both sets of parameters are rigid, time consuming and manually intensive. Moreover, they typically fail to utilize the sensors in their natural setting, namely, here, when tracking moving objects. As such, known methods of calibration often cause downtime of the sensors.

In a first example of known methods for calibrating internal parameters, a camera sensor is manually placed in a fixture and directed at objects, typically one or more checkerboards, of known dimensions. Key features of the objects are pointed out in the image, either manually or automatically in software. A mathematical operation, obvious to those skilled in the art, is carried out that consequently calculates the internal parameters of the camera from the known object dimensions. In a second example, a radar is manually placed in a fixture and directed at one or more devices of known location relative to that of the radar. The devices, typically a transponder, may return a signal to the radar with a predefined and known Doppler shift. This knowledge in conjunction with the relative positions of the devices allows one skilled in the art to calculate the necessary phase offsets of each of the radar's receivers.

Known methods for calibrating external parameters proceed in a similar manner. In a first example, a GPS-rover or similar may be used to manually extract the 3D location of the sensor. In the event that the sensor is a camera, the GPS-rover may equally be used to determine the 3D coordinates of a number of fix points visible to the camera. The camera then identifies the fix points in its own coordinate system, either automatically or by one manually pointing them out in an image. Consequently, a mathematical operation is carried out to further estimate the orientation of the camera in the GPS coordinate system. In a second example, a lidar scanner extracts relative 3D coordinates of a system of sensors that have a straight line of sight to the scanner. The scanner may have to be moved to multiple locations and the data may be stitched together to extract the positions of the sensors relative to one another. Other means must be adopted to determine the orientations of the sensors. In a third example, an inclinometer coupled to a sensor is used to determine portions of the external parameters of the sensor, namely its tilt and roll, based on a previously determined orientation of the sensor relative to the inclinometer.

Sensor parameters are typically held constant once calibrated. However, factors such as, e.g., temperature or age may result in drift of sensor parameters over time. As an example, a radar fixed to the stands of a baseball stadium and configured to track baseballs in flight may both translate and rotate as the stand onto which the radar is mounted is loaded with fans. Sensor parameters that drift necessitate repeated calibrations, however such calibrations may be cumbersome when the sensor is difficult to access and the calibration process requires manual intervention. Repeated calibrations may further be highly impractical if the calibration process causes downtime of the sensor from its normal operation.

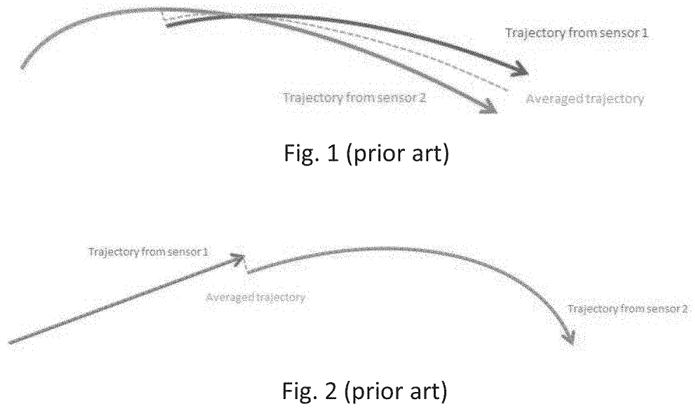

When the sensors of a multi-sensor system are inaccurately calibrated with respect to one another fusing data from the sensors may deteriorate the quality of the delivered data. In a first example, when two or more sensors monitor the same moving object at overlapping times, differences between the measurements from the various sensors may be addressed, for example, by a simple averaging, a weighted averaging, a Kalman filter, or other known mathematical approaches. FIG. 1 shows an example of inconsistent tracking data from two sensors producing an unphysical trajectory of an object at the beginning of the overlap region when the trajectories are averaged, albeit naively. In a second example, when two or more sensors measure the same moving object without overlap in time, their measurements may result in discontinuities at the point of transition between the sensors. FIG. 2 shows an example of inconsistent tracking data producing a discontinuous trajectory at the point where the object transitions from the field of view of one sensor to the field of view of the other sensor. The discontinuity of the final trajectory could for instance be lessened by smoothing a Kalman filter on the data instead, but the misaligned data would nonetheless still degrade the quality of the final trajectory.

### SUMMARY

The present disclosure relates to a method including capturing first data with a first sensor and second data with a second sensor in a multi-sensor tracking system, the first and second data corresponding to a path of an object, wherein each of the sensors has a set of initial parameters. The method further includes generating a first initial object track using the first data and the first initial parameters and a second initial object track using the second data and the second initial parameters, matching the first and second initial object tracks and determining a degree of correspondence therebetween; and calculating first optimized parameters for the first sensor, wherein, when a first optimized object track is calculated using the first data and the first optimized parameters, the first optimized object track and the second initial object track have a higher degree of correspondence therebetween than the first and second initial object tracks.

The present disclosure also relates to a system including a central processing arrangement in communication with a first sensor and a second sensor in a multi-sensor tracking system, the central processing arrangement receiving first data from the first sensor and second data from the second sensor, the data corresponding to a path of an object, wherein each of the sensors has a set of initial parameters. The central processing arrangement further generates a first initial object track using the first data and the first initial parameters and a second initial object track using the second data and the second initial parameters, the central processing arrangement matching the first and second initial object tracks and determining a degree of correspondence therebetween. The central processing arrangement calculates a first optimized sensor parameters for the first sensor, wherein, when a first optimized object track is calculated using the first data and the first optimized parameters, the first optimized object track and the second initial object track have a higher degree of correspondence therebetween than the first and second initial object tracks.

### BRIEF DESCRIPTION

FIG. 1 shows a first example of inconsistent data from two sensors producing a discontinuous track of an object according to prior methods.

FIG. 2 shows a second example of inconsistent data from two sensors producing a discontinuous trajectory of an object according to prior methods.

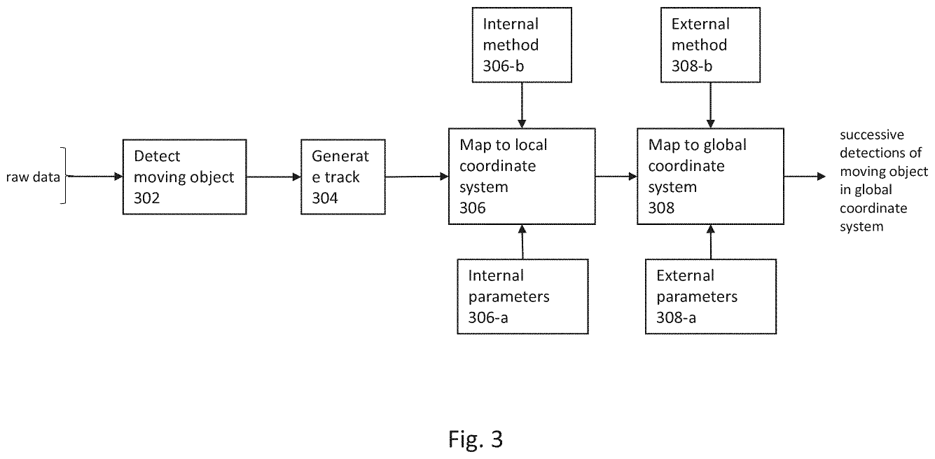

FIG. 3 shows an exemplary method for converting raw sensor data into a track of a moving object in a global coordinate system.

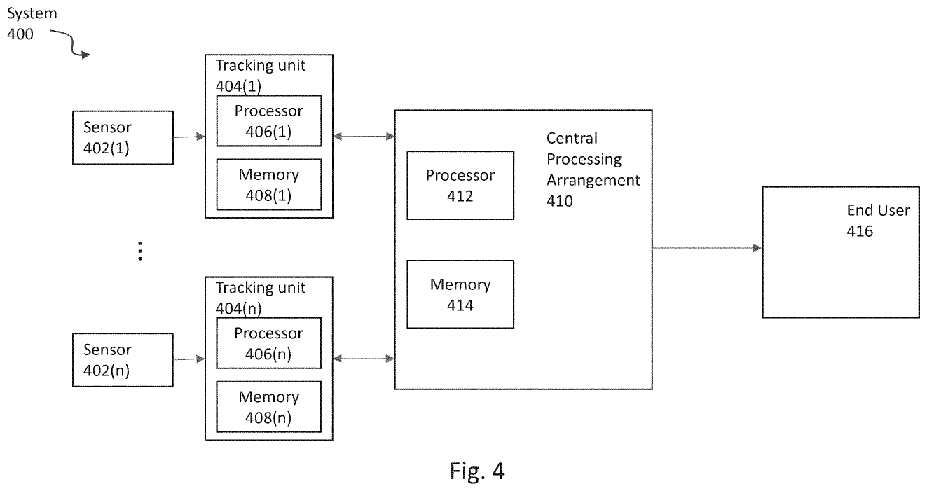

FIG. 4 shows an exemplary system for calibrating sensors in a multi-sensor tracking arrangement.

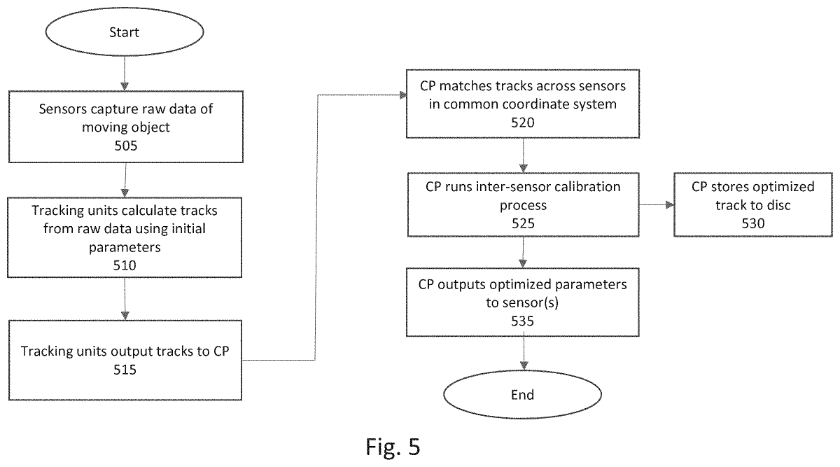

FIG. 5 shows an exemplary method for calibrating sensors in a multi-sensor system.

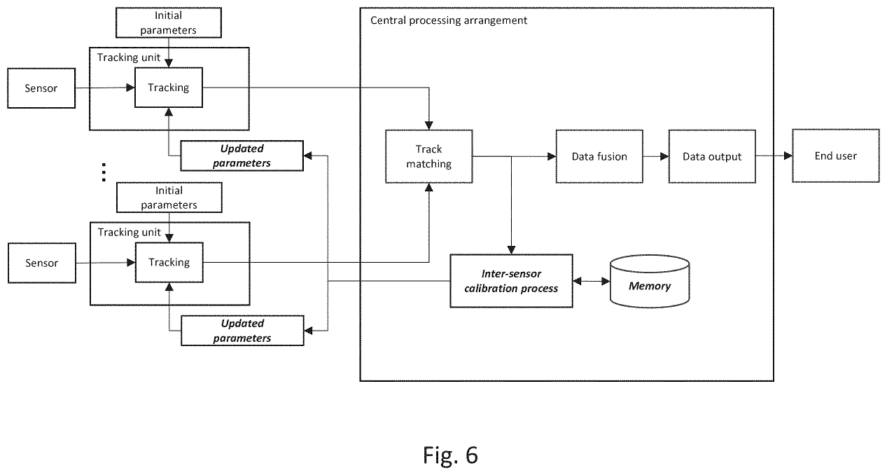

FIG. 6 shows the system of FIG. 4 with exemplary data flows and processing steps.

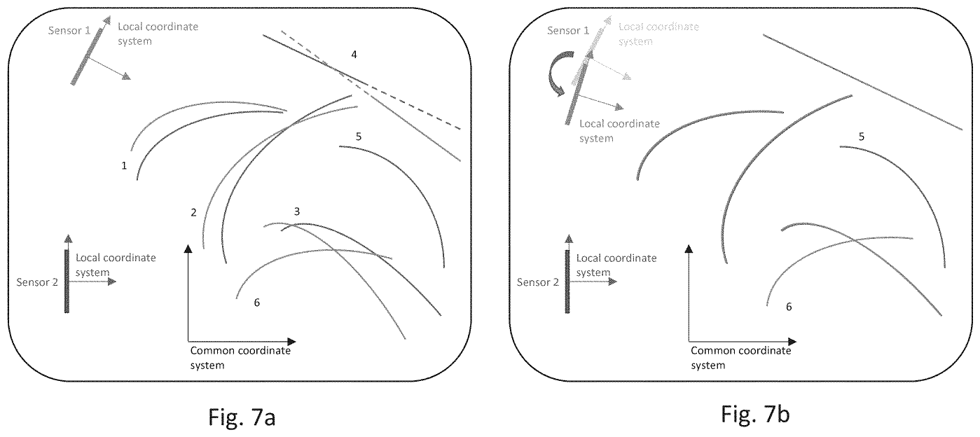

FIG. 7a-7b show an illustration of synthetic data before and after running the exemplary inter-sensor calibration.

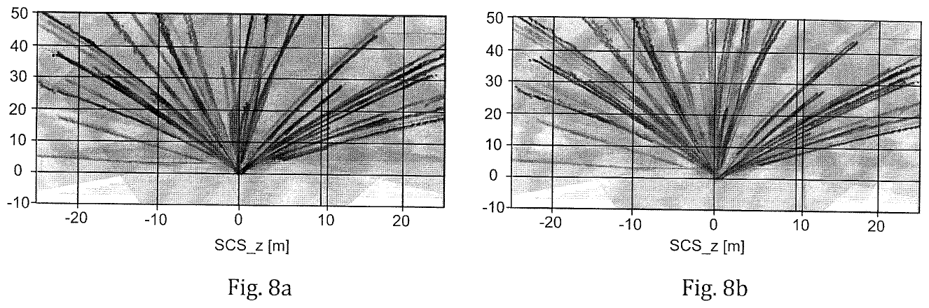

FIGS. 8a-8b show an illustration of actual measured data before and after running ₜhe exemplary inter-sensor calibration.

### DETAILED DESCRIPTION

The exemplary embodiments describe a learning system that automatically and adaptively determines some or all of the internal and external sensor parameters of one or more sensors in a multi-sensor system such that consistent and more accurate tracking data of sensed moving objects may be produced. The parameters are determined in situ and in near real time, without the need for manual intervention, and without downtime of the sensors from their normal operation.

During normal operation of the multi-sensor system, the sensors are configured to track moving objects. In one example, the multi-sensor system may be any number of cameras and radars situated at a golf course and configured to track golf balls in flight. The sensors produce redundant data when tracking the same moving object, and it is this redundant data that may be used to calibrate the internal and external parameters of one or more sensors to one another to produce consistent and more accurate tracking data.

The system consists of multiple sensors, each sensor feeding raw data to a tracking unit, which in turn communicates with a central processing arrangement (“CP”). The sensors serve to capture data of the moving objects of interest. The sensors may be a pulse, Doppler, CW, FMCW or MFCW radar, a visible or infrared camera, a lidar, an inertial measurement unit, etc., or any combination thereof.

Internal parameters of a sensor may be generally defined as parameters relating to the internal workings of the sensor. Examples may be a focal length, lens distortion parameters and a principal point for a camera; phase offsets and antenna radiation patterns for a radar; internal clock offsets for sensors in general, etc. When the internal parameters of a sensor are known with a high degree of accuracy the data received by the sensor may be processed to produce an output with a high degree of accuracy.

External parameters of a sensor typically constitute the position and orientation of the sensor with respect to a global coordinate system. Knowledge of the external parameters of a sensor allows one to map measured data from the coordinate system of the sensor to that of the global coordinate system, such that it may be compared with data from other sensors.

The tracking units, as defined here, serve to detect in the raw sensor data the moving objects of interest, and, where possible, to piece together successive detections of the same moving object into “tracks”. A track is therefore one or more detections of a moving object at successive times. For example, a camera may capture a number of consecutive images from a golf course. Its tracking unit may consequently extract the pixel location of e.g. a golf ball in each image, and the pixel locations of the golf ball in consecutive images are concatenated into a track of pixel locations in the local coordinate system of the camera.

A tracking unit may be an entity physically separate from the sensors and the CP, or alternatively an entity embedded in the sensor or integrated with the CP. A tracking unit will have an internal processing arrangement programmed to detect moving objects in the raw sensor data and to generate tracks of the detected moving objects, and will further have a memory storing the internal and external parameters of its sensor. The tracking unit may have compensated the raw sensor data for the internal parameters of the sensor to aid in tracking. For example, a tracking unit may scale and undistort the raw images from a camera before extracting pixel locations of the moving object of interest. In the event that a sensor is mobile, such as e.g. a camera affixed to a station that slides and/or rotates, and where this movement is internally monitored by components of the sensor, additional sensors mounted to the sensor, e.g., an inertial navigation system, or through image analysis, as would be understood by those skilled in the art, this information may equally be made available to the tracking unit to aid in piecing together measurements into tracks.

A tracking unit may furthermore have been guided in its tracking by the CP, which has knowledge of tracks originating from other sensors. For instance, on a driving range in which multiple cameras track golf halls in flight, one tracking unit may have detected a golf ball in flight in the raw image of its camera, which may be communicated to the CP. The CP in turn projects the detected golf ball into the images of the other cameras, through knowledge of the internal and external parameters of each camera as would be evident to those skilled in the art, such that their tracking units may search for the same golf ball in a suitable neighborhood around the projected point in their respective images.

Each one of multiple sensors measures objects in a coordinate system local to the given sensor. The sensors may measure not only from different perspectives but in different spaces. For instance, a camera sensor may measure two-dimensional pixel locations of an object in a series of images, while a radar sensor may measure in a 4-dimensional space comprising a three-dimensional position as well as a radial velocity of the object.

The CP serves to match tracks across sensors in a global coordinate system, as will be described later; to optimize sensor parameters such that matched tracks agree in a user-defined optimal manner; and to fuse matched tracks with optimized sensor parameters so that accurate data may be provided as output.

FIG. 3 shows an exemplary method for converting raw sensor data into a track of a moving object in a global coordinate system. In one embodiment, the sensor is a camera. In 302, the camera captures as raw data a series of images containing a moving object and detects a pixel location of the moving object in each of the images. In 304, the multiple, successive detections of the moving object are pieced together into a track. In 306, each pixel in the track is converted to normalized camera coordinates by supplying to the process the internal parameters (306-a) of the camera as well as the appropriate method (306-b) for carrying out the conversion, as would be known to those skilled in the art. Finally, in 308, each of the normalized camera coordinates in the track are mapped to a global coordinate system by supplying the external parameters (08-a) of the camera as well as the appropriate mathematical operation needed to perform the mapping (308-b). For a camera, the final output is a succession of rays in a global coordinates system locating a moving object of interest.

FIG. 4 shows an exemplary system 400 for calibrating sensors in a multi-sensor tracking arrangement. The system includes a plurality of sensors 402 (i.e., sensors 402(1)-402(n)), a plurality of tracking units 404 (i.e., tracking units 404(1)-404(n)), and a central processing arrangement (CP) 140. In other words, the system 400 may include any number of sensors 402 feeding raw data to tracking units 404, which in turn communicate with a single CP 410. The sensors 402 may be any sensors configured to track movement (of, e.g., objects or people), e.g., a radar array, a camera, a lidar, etc. The sensors 402 may be fixed at a location or may be mobile. The tracking units 404 may each have an internal processor 406 and memory 408 configured to perform calculations on raw sensor data and output tracks to the CP 410 corresponding to successive measurements and detections of moving objects in the raw sensor data. Sensor parameters, stored in memory 408, may additionally be passed from the tracking units 404 to the CP 410. Alternately, as discussed above, one or more of the tracking units 404 may be implemented at the CP 410.

The CP 410 includes a processor 412 and a storage 414. The CP 410 is coupled to the sensors 402 through their tracking units 404, and is configured to receive tracks and sensor parameters from and send guidance to the tracking units 404. The CP 410 may further be configured to output data to an end user 416. The end user 416 may be, for example, a display or a further processing apparatus. The processor 412 of the CP 410 may include a plurality of processors; in some embodiments, the CP 410 may process the tracks of dozens or hundreds of objects simultaneously, which would require a relatively high computing power. The CP 410 has executable instructions stored thereon for performing tracking-related calculations. For example, the CP 410 may match tracking data received from the sensors, perform the inter-sensor calibration process, and fuse the tracking data for outputting object tracks to the end user.

The parameters of sensors 402 may have been calibrated at an earlier time, with their parameters stored in memory 408 of the tracking units. The existing calibration may have been from a factory calibration of the sensors or from a previous run of the inter-sensor calibration procedure outlined herein.

FIG. 5 shows an exemplary method 500 for calibrating sensors 402-once-in a multi-sensor system. The calibration is notably carried out during normal operation of each of the sensors.

As discussed previously, a set of existing parameters may be stored for each of the sensors 402 in memory 408. Any of a variety of means known in the art may have been used for determining these parameters including the exemplary calibration procedure to be explained in detail below.

In 505, the sensors 402 capture raw data corresponding to at least one moving object. The sensors 402 may be deployed at or around the tracking location to track multiple moving objects simultaneously, such as, e.g., golf balls at a driving range. However, only one moving object need be tracked to perform the exemplary calibration procedure.

In 510, the tracking units 404 of each sensor 402 individually determine tracks for the portion of the object motion that the sensor 402 has generated the raw data for. The tracks are determined by performing calculations on the raw data, potentially using the existing sensor parameters retrieved from memory 408. It is not a requirement that the tracks from the tracking units 404 overlap in time, even partially. For example, a first sensor 402(1) may measure the beginning of a track, while a second sensor 402(2) measures a later portion. A dynamical model relevant for the object (e.g., Newton's second law and knowledge of the aerodynamic properties of the moving object) allows the CP 410 or other processor to extrapolate the tracks both forward and backward in time to increase the amount of overlap such that the two tracks may be more easily compared with one another as would be understood by those skilled in the art.

In 515, each tracking unit 404 outputs to the CP 510 the respective tracks it determined in 510 along with sensor parameters stored in memory 408.

In 520, the CP 410 matches tracks across sensors 402 in a global coordinate system. The process of converting from raw data to data in a global coordinate system was outlined in FIG. 3. The tracks are matched by identifying unique characteristics exhibited by each track. Such characteristics may be, e.g., synchronization of object positions and times; object velocity; spin rate; spin axis; location and timing of object bounces; the object's color or reflection coefficient; etc. Not all tracks may be matched across sensors. For example, a portion of the motion of a first object may be obscured by an intervening structure or the motion of a second object from the perspective of one of the sensors 402, such that the sensor 402 fails to capture data from and generate a track for a first object at a given time. Moreover, some tracks may be matched for some sensors while other tracks may be matched for other sensors. As noted previously, the tracks may be extrapolated forward and/or back in time to better compare the tracks. The CP 410 having knowledge of the existing parameters of the sensors allows the CP 410 to project the tracks (generated in sensor coordinate systems) into a global coordinate system with a global clock.

Once matched, in 525, the CP 410 runs an inter-sensor calibration process, to be explained in detail below. The inter-sensor calibration process adjusts internal and external parameters of one or more of the sensors 402 so that sensor tracks agree in an optimal manner in a global coordinate system. In optional 530, the sensor tracks are stored to memory 414 for use in future calibration processes, to be explained in detail below.

In 535, the optimized parameters are returned to the tracking units 404 of each sensor 402. Each tracking unit 404 may update its existing parameters stored on memory 408 with the optimized parameters and use the updated parameters for future tracking. In this way, the sensors 402 are calibrated to generate consistent tracking data when the individual tracks are fused in the CP 410. For future tracks (until any further adjustment is necessary), the CP 410 need not perform calculations to make the received tracks consistent, as the tracks should already be consistent given the calibrated parameters. The CP 410 can simply fuse the tracks in a global coordinate system and output the combined track to the end user 416.

FIG. 6 shows the manner in which the inter-sensor calibration process and its feedback is integrated into the normal operation of the multi-sensor system. During normal operation, the sensors capture raw data from which moving objects are detected by tracking units. Tracks of moving objects may consequently be matched and fused before being outputted to an end user. The inter-sensor calibration process may be implemented in parallel such that no sensor downtime is necessary. The inter-sensor calibration process may be run, and optimized parameters may be returned to their respective tracking units for future tracking.

The inter-sensor calibration process determines internal and external parameters of the sensors 402 such that the tracks generated by the tracking units 404 agree spatially and/or temporally in an optimal way in a global coordinate system.

Optimality may be user-defined. In a preferred embodiment, optimality will constitute minimizing the weighted 3d-positional residuals between tracks. Algorithmically, one typically defines a cost function, E, to be minimized. When minimizing positional residuals, this cost function could look as follows for a single matched track, t:

$${E}_{track t} = {\sum }_{sensor i} ( {\sum }_{sensor j \neq sensor i} ( {\sum }_{position {n}_{t}} ( {‖ {x}_{i}^{{n}_{t}} - {x}_{j}^{{n}_{t}} ‖}_{{w}_{ij}^{{n}_{t}}} ) ) ) .$$

In the above function, xᵢⁿ^{^{t}} is an estimate of the nth position of an object in a global coordinate system belonging to track t, which has been detected or estimated by the tracking unit associated with sensor i and which is a function of the latest estimate for sensor i's internal and external parameters. ∥·∥_{w}_{ᵢⱼ}_{^{nt}} represents the weighted 2-nonn of its argument under some user-defined weight matrix Wᵢⱼⁿ^{ₜ}.

Data from a given sensor 402 may have qualities that lend the data a high degree of confidence, while other data from other sensors 402 may have qualities indicating a low degree of confidence. Where high quality data may be compared with other high quality data, greater weight is placed, which may be reflected in weight matrix Wᵢⱼⁿ^{ₜ}. If all data is of equal weight, the weight matrix may be set to the identity matrix. Examples of measurements with low confidence are, e.g., measurements that are noisy; measurements outside the “space” of the sensor, for instance the depth of an object in an image; or measurements that have been arrived at by extrapolating a dynamical model.

In another embodiment, the cost function to be minimized may be a function of the residuals in velocity, spin axis, accelerations, pixels, pixel intensities, etc. or any weighted combination thereof As an example, a multi-sensor system may consist of a radar and a camera detecting a moving object, say a golf ball. Ball positions, as detected by the radar, may be projected into the image plane of the camera, and a cost function may be defined that minimizes residuals in pixel coordinates between that of the camera and that of the radar's projection. In another example, two cameras may track a baseball in flight that travels across a volume where the lighting changes, such that the ball becomes increasingly dark as viewed by each camera.

The difference in pixel intensity monitored by each camera may additionally be incorporated into the cost function, such that the cost function to be minimized could be a function of not only pixel coordinates but also pixel intensities.

In the event that multiple tracks have been matched by the CP, the cost function may be written as a weighted sum of costs of each track, i.e.:

$$E = {\sum }_{tracks t} {w}_{t} \times {E}_{track t}$$

where wₜ is the weight assigned to each track t. By default, the weights assigned to each track may be assumed to be identical, i.e. wₜ=1.

Arriving at optimality, namely minimizing E, may be done numerically and may be carried out by the CP. In its simplest form, the CP may do a brute-force grid search across all parameters—internal and external—for all sensors and select the parameters that minimize the cost function. This may equally be done by sampling a small grid around an intelligent guess for all parameters, if such an intelligent guess exists. In another embodiment, intelligent optimization techniques may be utilized. Examples of such techniques are the Nelder-Mead algorithm and—where derivatives of the cost function may be evaluated—the Gauss-Newton algorithm, the Levenberg-Marquardt algorithm, or other gradient descent-based algorithms.

After the cost function E is minimized and the optimized internal and external parameters are determined the optimized parameters may be returned to each sensor for future tracking.

Depending on the nature of the multi-sensor system and user preferences the inter-sensor calibration process may be implemented in a variety of ways. In one embodiment, inter-sensor calibration is carried out once, say at installation, after which the internal and external parameters are considered calibrated and constant in time. One or more tracks may be collected and stored to disc during installation, after which the inter-sensor calibration routine may be run.

In another embodiment, the inter-sensor calibration process may be run continuously, such that the internal and external parameters of each sensor are continuously updated for each newly identified track or tracks. The newly identified track or tracks may be appended to a list of some or all historically identified tracks, retrieved from memory, and inter-sensor calibration may be run.

In still another embodiment, a newly identified track or tracks may be appended to a list of some or all historically identified tracks, retrieved from memory, and inter-sensor calibration may be run. In this embodiment, however, the internal and external parameters of some or all sensors may be assumed to have drifted in time during the collection of tracks. To account for this, the tracks may be weighted exponentially in time such that more recently identified tracks may be given greater weight during the inter-sensor calibration process. Such a weight function could take the form wₜ=e^{-λΔτ}, where Δτ is the time in seconds since the track was observed and λ is a user-defined decay-rate constant.

In still another embodiment, the aforementioned drift of some or all sensors is monitored by one or more means, for instance an inertial motion unit (IMU) built into the sensor. The measured drift may be accounted for by the CP during the optimization step of inter-sensor calibration, such that tracks again with benefit may be given equal weight in the cost function to be minimized, i.e. wₜ=1.

In still another embodiment, there may not be time and/or resources to do a full run of the inter-sensor calibration of all tracks, both new and from memory. There may simply be too many tracks, on the order of millions. Instead, one may adopt a stochastic or mini-batch gradient descent approach as is known to those skilled in the art. Upon receiving a newly identified track or tracks, the CP 410 may first store the most recent set of parameter values for all sensors as paramₖ₋₁. Next, the CP 410 may calculate the optimal set of parameter values based on the newly received track or tracks by running the inter-sensor calibration on just that track or those tracks. This set of parameter values is stored as paramₖ. Lastly, the CP 410 approximates the optimal set of parameter values for each sensor as a weighted sum of the above, i.e. w×paramₖ+(1−w)×paramₖ₋₁, where 0≤w≤1 is a used-defined weight. Heuristics for setting user-defined w will be known to those skilled in the art.

In all cases, the updated values of all internal and external sensor parameters may be sent to the tracking unit of each sensor for future tracking.

The inter-sensor calibration process may be set up such that any one or more sensor parameters of any particular sensor are optimized. In other words, not all sensor parameters need to be optimized. As a first example, in a venue which is a golf driving range onto which multiple radars are mounted, it may be that only the pan angle of each radar is chosen to be optimized through the inter-sensor calibration process, while all remaining internal and external sensor parameters are arrived at by other means. Restricting optimization to some but not all parameters of a sensor is equivalent to performing a constrained optimization, which may be familiar to those skilled in the art.

The inter-sensor calibration may be implemented in a variety of settings. For example, the process may be run at venues where multiple sensors, similar or not, are required to capture the entire volume in which a moving object may move. At venues such as a golf driving range, a hole on a golf course, a baseball stadium, a football stadium, or any other stadium, the multiple sensors may track sports balls or ball-like objects and combine tracking data across the many sensors to output a single track to, e.g., a broadcast display. These venues may also require precision measurements, where sufficient overlap between sensors is required for redundant measurements. Minimizing the variance of the combined measurements and rejecting outliers may enhance the precision of the system.

Some venues may utilize a reference sensor delivering a categorical output to which one or more sensors must be calibrated. For example, in baseball, the reference sensor may be a human, i.e., the umpire, and the output is the call of the pitch, i.e., a strike or a ball. One or more second sensors may capture the trajectory of the ball during the pitch. The parameters of the second sensors may thus be updated such that calls proposed by the second sensors correlate well with that of the reference sensor, here the umpire.

Still other venues may combine sensors that measure a full trajectory of an object with sensors that measure only parts of the trajectory. The full-trajectory sensors may measure the object with less accuracy than the part-trajectory sensors. An example of such a system is adding a high-precision golf launch monitor to a driving range onto which sensors already exist that measure the full trajectory of the ball. By calibrating the external parameters of the launch monitor such that it aligns with the sensors already installed on the range, detailed data may be given on a shot, both at impact as well as throughout its flight. The high precision golf launch monitor may be a portable unit, which is set up by the golfer himself. This method of calibration of the portable golf launch monitor could then be done automatically without any operations from the golfer's side.

Still other venues may implement multiple sensors that have not yet been time synchronized. One example of such is two sensors tracking the trajectory of a baseball pitch, one correctly in time and another offset by some Δt. After having matched the two tracks in the CP, inter-sensor calibration may be carried out that attempts to minimize e.g. the positional residuals between the two tracks by offsetting the track in the second sensor by −Δt.

In another embodiment, an inertial measurement unit (IMU) is mounted onto e.g. a golf club and is used in conjunction with a radar and/or camera tracking the swing of the club. The IMU captures parameters of the club, say its velocity and orientation, during the swing of the club. By comparing with similar measurements from the radar and/or camera the position and orientation of the IMU may be determined. Other examples onto which the IMU may be mounted may be a tennis racket, a baseball bat, a cricket bat, etc.

FIGS. 7a-7b show an illustration of synthetic data before and after running the exemplary inter-sensor calibration. In FIG. 7a, first and second sensors have tracked a plurality of moving objects and the tracks have been initially matched by the CP 410. The tracked objects have been given a number 1-6 for clarity. For objects 1-3, the sensors have captured overlapping data sufficient for running the calibration. For object 4, portions of the tracks have been arrived at by extrapolating a dynamical model forwards and backwards in time, visualized by dashes. For object 5, only the second sensor has produced a track. In other words, none of the tracks calculated by the first sensor have been matched to a track calculated by the second sensor. For object 6, the opposite situation has occurred-only the first sensor has produced a track for the object. The tracks display significant residuals in their positional estimates, visualized by the tracks not overlapping in space.

In FIG. 7b, the inter-sensor calibration has been run. In this example, only the external parameters of the first sensor have been optimized such that matched tracks agree in an optimal manner based on their positional residuals. As shown in FIG. 7b, the tracks of the first sensor have been both translated and rotated.

FIGS. 8a-8b show an illustration of actual measured data before and after running the exemplary inter-sensor calibration. The illustration shows a top view of the tracks of a number of baseballs struck with a baseball bat at an MLB stadium. The sensors used to generate the tracks are radars. Only tracks that have been matched across radars are shown. To every track captured with every radar, a dynamical model has been fitted that both estimates the ball's position from the time of being struck until landing as well as quantifying a confidence in the radar's estimate of the ball's position. These are shown as faded error bars, and are used as weights in the cost function to be minimized. Every tracked ball has been given a marker associated with the radar having tracked it.

In the uncorrected data shown in FIG. 8a, there exists a clear discrepancy between estimates of the ball's positions across radars. In the corrected data shown in FIG. 7b, following the inter-sensor calibration procedure, the internal parameters of the radars (i.e. their phase-offsets) have been optimized and updated, such that the residuals have been significantly reduced.

1. A method, comprising:
capturing first data with a first sensor and second data with a second sensor in a multi-sensor tracking system, the first and second data corresponding to a path of an object, wherein each of the sensors has a set of initial parameters;
generating a first initial object track using the first data and the first initial parameters and a second initial object track using the second data and the second initial parameters;
matching the first and second initial object tracks and determining a degree of correspondence therebetween; and
calculating first optimized parameters for the first sensor, wherein, when a first optimized object track is calculated using the first data and the first optimized parameters, the first optimized object track and the second initial object track have a higher degree of correspondence therebetween than the first and second initial object tracks.

2. The method of claim 1, further comprising:
calculating second optimized parameters for the second sensor, wherein, when a second optimized object track is calculated using the second data and the second optimized parameters, the first and second optimized object tracks have a higher degree of correspondence therebetween than the first and second initial object tracks.

3. The method of claim 2, further comprising:
projecting the first and second object tracks into a global coordinate system.

4. The method of claim 3, further comprising:
fusing the first and second object tracks into a fused object track; and
outputting the fused object track to an end user.

5. The method of claim 1, wherein the first sensor has an associated first tracking unit storing the first initial parameters and processing the first data with the first initial parameters to generate the first initial object track.

6. The method of claim 5, further comprising:
returning the first optimized parameters to the first tracking unit; and
storing the first optimized parameters on the first tracking unit for calculating future object tracks.

7. The method of claim 1, further comprising:
calculating the first initial object track in a first local coordinate system and the second initial object track in a second local coordinate system.

8. The method of claim 1, wherein a central processing unit stores the first and second initial parameters and receives the first and second data directly from the first and second sensors.

9. The method of claim 1, wherein either one of the first and second sensors is a radar and the other one of the first and second sensors is an imager.

10. The method of claim 2, further comprising:
defining a cost function for minimizing positional residuals between the first and second initial object tracks.

11. The method of claim 10, further comprising:
performing a brute force grid search across the first and second initial parameters to generate the first and second optimized parameters that minimize the cost function.

12. The method of claim 11, wherein the cost function is defined to process a plurality of tracks of a plurality of objects.

13. The method of claim 12, wherein a first track is accorded greater weight than a second track in the cost function when the first track is more recent in time than the second track.

14. The method of claim 12, wherein a first track is accorded greater weight than a second track in the cost function when the second track is noisier than the first track.

15. The method of claim 1, wherein the object s any one of a golf ball, a baseball, a soccer ball or a football.

16. The method of claim 1, wherein the first and second initial object tracks do not overlap in time.

17. The method of claim 1, wherein certain of the first initial parameters are excluded from optimization.

18. The method of claim 1, wherein the second sensor is a reference sensor to which the first sensor is calibrated.

19. A system, comprising:
a central processing arrangement in communication with a first sensor and a second sensor in a multi-sensor tracking system, the central processing arrangement receiving first data from the first sensor and second data from the second sensor, the data corresponding to a path of an object, wherein each of the sensors has a set of initial parameters, the central processing arrangement generating a first initial object track using the first data and the first initial parameters and a second initial object track using the second data and the second initial parameters, the central processing arrangement matching the first and second initial object tracks and determining a degree of correspondence therebetween, and the central processing arrangement calculating first optimized sensor parameters for the first sensor, wherein, when a first optimized object track is calculated using the first data and the first optimized parameters, the first optimized object track and the second initial object track have a higher degree of correspondence therebetween than the first and second initial object tracks.

20. The system of claim 19, further comprising:
a first tracking unit associated with the first sensor, the first tracking unit storing the first initial parameters and processing the first data with the first initial parameters to generate the first initial object track.
